(19) United States
(12) Patent Application Publication
(10) Pub. No.: US 2008/0228685 A1
(43) Pub. Date: Sep. 18, 2008

(54) User intent prediction

(75) Inventors: Vishnu Kumar Shivaji-Rao, Vancouver, WA (US); Fernando Amat Gil, San Francisco, CA (US)

Correspondence Address: KEVIN L. RUSSELL;CHERNOFF, VILHAUER, MCCLUNG & STENZEL LLP, 1600 ODSTOWER, 601 SW SECOND AVENUE, PORTLAND, OR, 97204, US

(73) Assignee: Sharp Laboratories of America, Inc.

(21) Appl. No.: 11/717,566

(22) Filed: Mar. 13, 2007

(51) Int. Cl. G06N 5/02

(52) U.S. Cl. 706/46

(57) ABSTRACT

In a process comprising a sequence of elections, a future election intended by a user is predicted from a frequent sequence of elections by the user and a frequent sequence of elections by a plurality of other users of the process or device.

### CROSS-REFERENCE TO RELATED APPLICATIONS

Not applicable.

### BACKGROUND OF THE INVENTION

The present invention relates to processes requiring a sequence of elections by a user and, more particularly, to a method of predicting a future election by a user based on frequent sequences of elections made in the past by the user and others.

As consumer electronic devices have become more powerful and complex, users are encountering greater difficulty in configuring and using these devices. For example, a user of a word processing program may need to make multiple, sequential elections to change the size of the paper for a document. Initially, the user must choose from a substantial number of icons or menu titles on a menu bar to cause a menu to be displayed. If there are too many items to be displayed on an initial menu, the user may be required to select longer menu containing additional options. The user may then select a topic from the menu to cause a tabbed interface to be displayed. If the user has made the correct elections in this sequence of interactions, the word processor may display a tabbed interface permitting the user to select a PAPER tab enabling the user to elect the desired paper size. New users of the word processor or other consumer electronic device may have difficulty making the correct election at any interaction in the required sequence because the final step in the sequence is not visible to the user until it is elected and often the names of the steps or the icons representing the steps comprising the sequence seem to bear little relation to the desired result.

Assistance in making the required sequence of elections may be available in a printed operating manual or through a displayable HELP system. However, as electronic devices have become more powerful and complex, the operating manual has become substantially larger and may be larger than the device itself. As a result, it is often unavailable when needed. Displayable HELP systems are often complex requiring considerable searching to find the appropriate assistance and are typically not displayable while the user is making the series of required elections.

What is desired, therefore, is a method for assisting a user in making a series of elections in a sequential process.

### BRIEF DESCRIPTION OF THE DRAWINGS

FIG. 1 is a flow diagram of a method of collecting frequent sequences of elections.

FIG. 2 is block diagram of a frequent sequence identification process.

FIG. 3A is a flow diagram of a method for predicting a user's intent from frequent sequences of elections.

FIG. 3B is a continuation of the flow diagram of FIG. 3A.

TABLE 1 is an illustration of an exemplary dataset comprising a plurality of election sequences.

### DETAILED DESCRIPTION OF PREFERRED EMBODIMENTS

Many tasks require that an individual perform a sequence of elections or actions. Devices, including consumer electronic devices, commonly include menu driven interfaces that require the user to select one of several icons or menu choices in a top level interface followed by another election in a second level interface and so on. Often, an item in the menu or an icon to be selected by the user, at some point in the sequential path, does not clearly suggest the end result desired by the user causing confusion, errors and frustration. In addition, tasks performed least frequently often require the longest sequence of elections. Devices are often equipped with a HELP system that includes a recitation of the elections to be made by the user to accomplish a desired result, but the help system is typically unavailable to the user after the user has started making the series of elections necessary to accomplish the result. As electronic devices have become smaller, more portable and more powerful, the operating manual has become larger and is often larger than the device itself. As a result, the operating manual is often unavailable when the user requires assistance. Devices requiring a sequence of elections during set up and operation are often confusing and frustrating for users and for new users, in particular. The inventors concluded that a system that predicted the user's intention during execution of a process requiring a sequence of elections would assist the user in making future elections and reduce errors and frustration. Such a system could, for example, simplify set up and operation of many devices and improve the satisfaction of users.

The user intention prediction method predicts the outcome of a future election by the user from a sequence of contemporaneous elections made by the user, one or more frequent sequences of past elections made by a plurality of users and one or more frequent sequences of past elections made by the individual user making the current elections. Data gathered during past performances of various tasks by a number of users, including the current user, is collected and analyzed to determine the most frequent sequences of elections. When the user initiates a series of elections to perform a task, the method records each election in the sequence and appends the most recent election to the sequence of prior elections defining the path being pursued by the user. The path or sequence being currently selected is compared to the most frequent sequences of elections by a group of users and by the current user and the current intent of the user predicted. Based on the prediction, relevant information can be displayed or other action undertaken to assist the user in making the additional or future elections that will be necessary to achieve the desired end result.

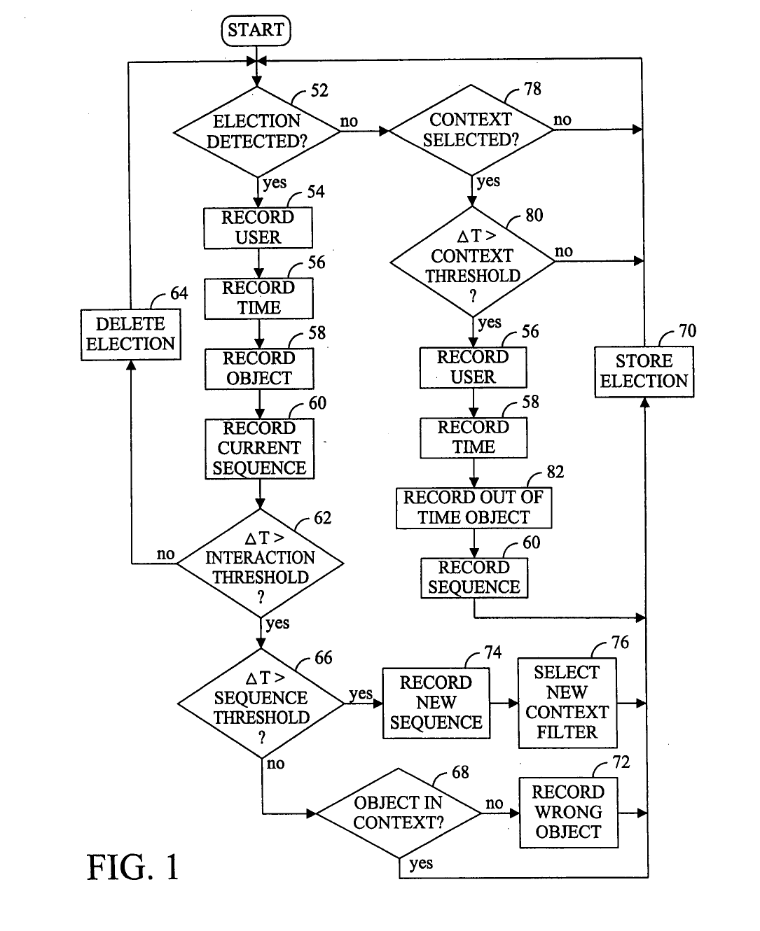

Referring in detail to the drawings where similar parts are identified by like reference numerals, and, more particularly to FIG. 1, data concerning elections made by users during execution of a plurality of sequential processes, such as sequences of interactions to set up or alter a method of operation of a device, are recorded and stored in a database. A sequence is a temporal series of elections or choices of objects. For example, in a menu driven interface, such as those commonly used with consumer electronic devices, users must sequentially choose between a plurality of objects, for example, displayed icons or menu items. An object can be any action; for example, depression of a button on a remote control or a mouse; or any state for a device or process; for example, highlighting or selecting a icon or menu option, that is selectable by the user.

When an election is detected 52, the identity of the user 54, the time of the election 56, the identity of the object elected 58 and the identity of the current sequence 60re recorded in a buffer. A plurality of sequence identities are assigned to each context applicable to the device's operation. For example, when the user of a television depresses the MENU key of the remote control, the system records the election of the MENU object and establishes that subsequent elections in the sequence will be in the menu context. The context of a sequence is defined by the user's initial election in the sequence.

The time interval between the current election and the previous election is compared to an interaction threshold interval 62. If the interval between elections is less than the interaction threshold, the user is presumed to have passed through the election without taking action and the quartet of data; user, time, object and sequence; comprising the recorded election is deleted from the buffer 64. If the user does not make a second election before the expiration of the interaction threshold, the object elected is considered to be an element of a sequence being executed by the user and the object identity is eligible to be appended to the end of the current path or sequence. If the time interval between elections exceeds the interaction threshold interval, the interval between elections is compared to a sequence threshold interval 66.

To reduce the time required to predict the user's intention, it is preferable to determine the more frequent sequences in each context that the user may select in operating the device. Further, certain objects may not be selectable in certain contexts. For example, the volume of a television may not be adjustable when the MENU context has been selected and selection of the VOLUME button on the remote control is inappropriate for the context. The complexity of recorded sequences is reduced by recognizing user errors in making elections that are inappropriate for the current context selected by the user. A context filter determines if the object identification stored in the buffer is permitted for the current context 68. If the object is permitted for the current context, the identities of the user, time of election, object and sequence contained in the buffer are stored in a database 70. If not, the object identification stored in the buffer is replaced with a filtered object identification indicating that the WRONG object was elected and the data describing the election including the object WRONG is stored in the database. Referring to Table 1, the database comprises data quartets including the sequence id 150, the user id 152, time id 154 and object id 156, describing an election which are stored for subsequent analysis. Following storage of a data quartet describing an election and the method awaits the detection of the next election.

If the interval between successive elections exceeds the sequence threshold interval 66, the current sequence identification stored in the buffer is replaced by a new sequence identification 74 having a context determined by the object identification recorded in the buffer and a new context filter is selected 76 for application to subsequent elections in the new sequence.

If an election is not detected 52, the system determines if a context for a sequence has been selected 78. If no context has been selected, the method continues to monitor the process and await an election. However, if a context has been selected, the user must make an election within a specified context threshold interval 80. If the interval between the current time and the time of the last election is less than the context threshold, the method continues to monitor for the next user election. However, if the interval between the current time and the time of the last election exceeds the context threshold interval for the current context, an OUT OF TIME object 82 will be stored in the database with the identity of the user 56, the time 58, and the current sequence 60 to reduce the quantity of data stored in the database.

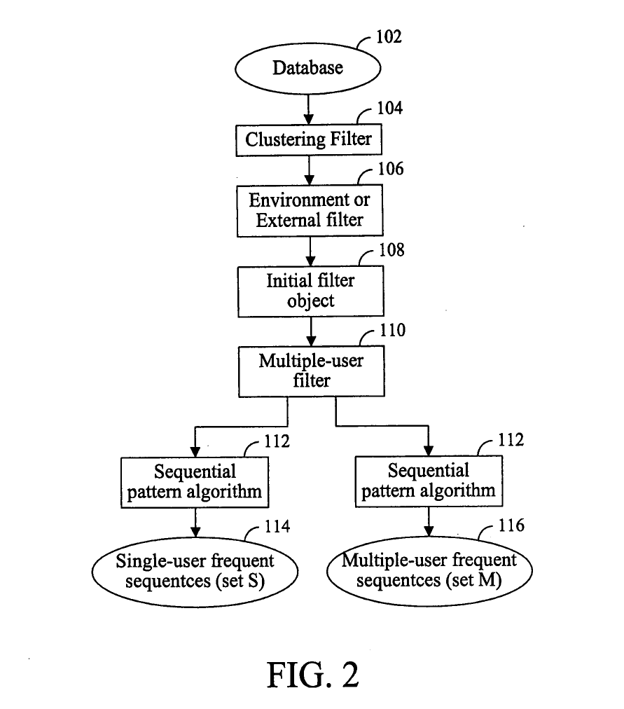

Referring to FIG. 2, after the sequences have been captured, the sequences are combined for all users and frequent sequences of different lengths are mined from the database 102. A subset of the data is obtained by filtering the dataset comprising all sequences from all users. Initially, a clustering group filter is applied to organize the sequences into groups that are similar 104. A number of clustering algorithms, including K-Means clustering and Expectation Maximization (EM) clustering, can be applied to segment the dataset. The dataset is segmented into three clusters (satisfied, confused or frustrated) that indicate the level of user confusion in each of the available contexts. User confusion segmentation is based on the median length of frequent sequences, median of the maximum number of occurrences of the same object in a sequence, the average duration to perform a sequence, and the median of the number of occurrences of WRONG or OUT OF TIME objects in the captured occurrences of a sequence. Additional context dependent attributes can be added to the clustering filter to further refine the clustering, if desired.

The clustered sequences may also be filtered for environmental or external factors 106 that are not directly related to the process comprising the sequence or the device on which the process executed. For example, groups of frequent sequences may differ at different times of the day, day of the week, geographical location or as the result of other external factors which may effect the user's intent.

An initial object filter identifies the sequences in the dataset that have the same initial object or context 108. In the prediction process, the sequence or path being currently pursued by the user will be compared to frequent sequences having the same context or initial object.

The filtered dataset is further segmented by a multi-user filter 110 that segments the sequences into a multi-user set comprising frequent sequences from all users and single user set that contains only the frequent sequences produced by the current user. The prediction process utilizes both the multi-user set of frequent sequences and the single user set of frequent sequences to predict intent. The past activities of the current user are expected to be a better predictor of the user's current intent than the actions of a group of users, but if little is known about the current user the multi-user set of frequent sequences provides a basis for determining the current user's intent.

A sequential pattern algorithm analyzes the series of elections in each sequence to eliminate duplicate sequences and determine a plurality of frequent sequences for each of the single user and multi-user datasets 112. The results of the filtering and sequential pattern recognition are single user 114 and multi-user 116 sets of contextually segregated, frequent sequences of elections by a plurality of users and by the current user.

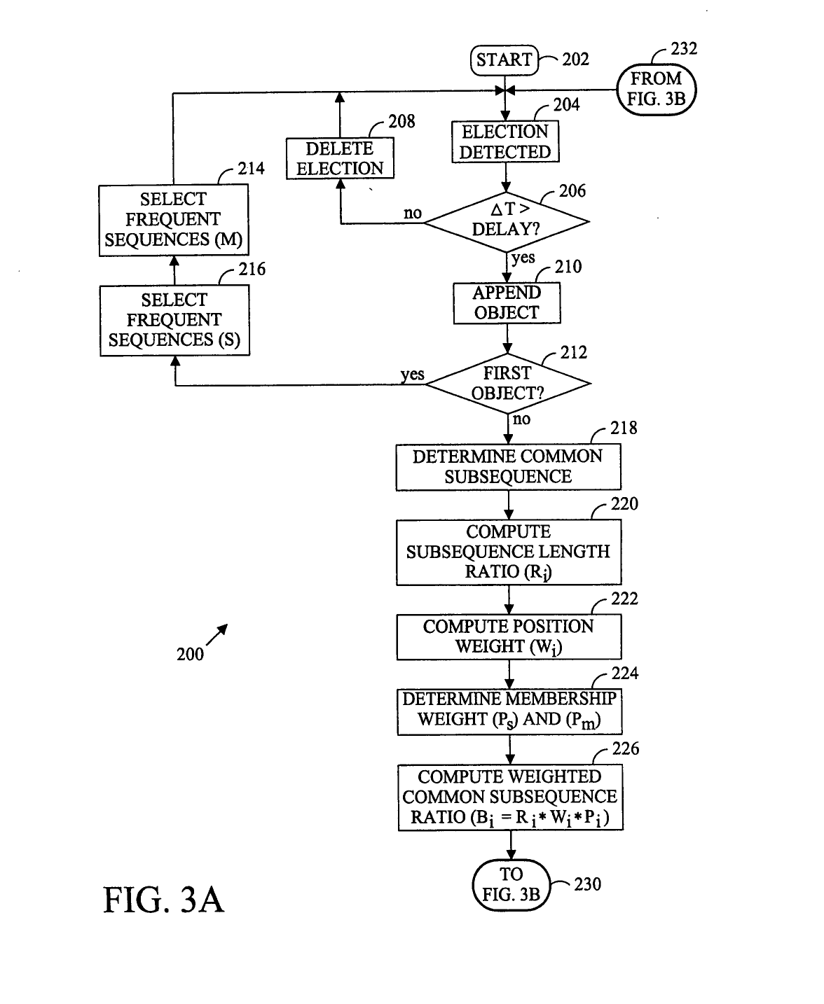

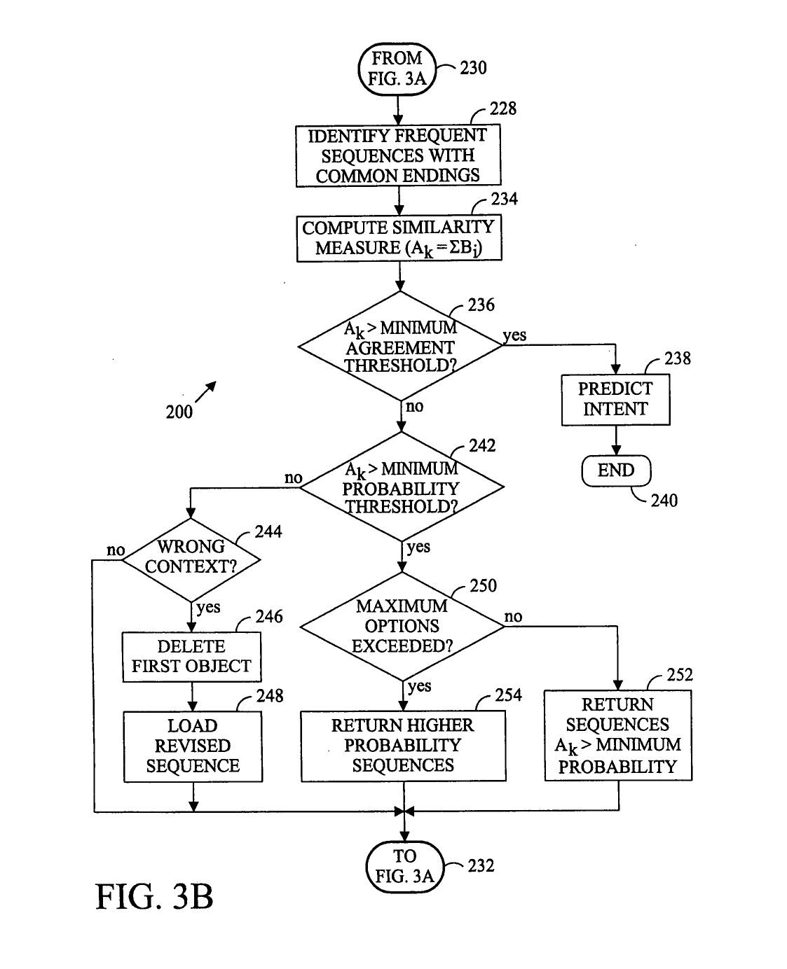

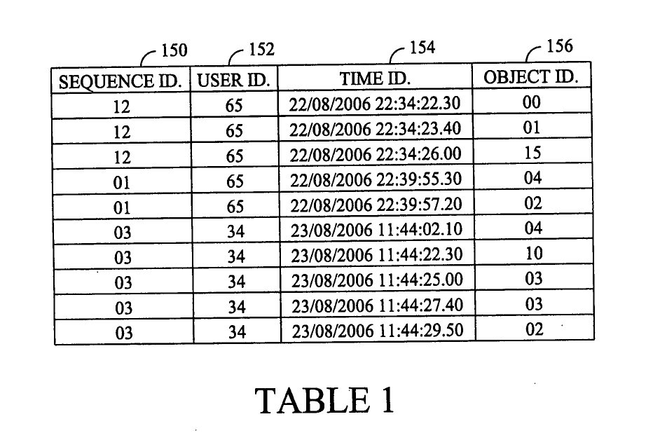

Referring to FIGS. 3A and 3B, when the user engages in a sequential process by making an initial election, the user prediction method is initiated 202. The election is detected 204 and the method waits for a pre-selected time delay 206. If the user makes a new election before the end of the delay, the earlier election is considered to have been inadvertent and is ignored and the object of the election is deleted 208. If the user does not make a second election before the expiration of the delay interval, the object elected is considered to be an element of a sequence being executed by the user and is appended to the current sequence being selected by the user 210. If the object is the first election in a new sequence 212, the object defines the context of the sequence and the multi-user 214 and single user 216 sets of frequent sequences for the context elected by the user are selected. By way example, a user electing object C as the first object of a sequence might cause the following exemplary sequences to be selected from the multi-user and single user sets of frequent sequences:

Sequence 1 (Set Single User): C>B>A>C>D>D>A>E>F>A>G

Sequence 2 (set Single User): C>A>D>E>E>C>I

Sequence 3 (Set Multi-User): C>C>E>F>H>C>I

Sequence 4 (Set Multi-User): C>A>D>F>E>H>B>A>G

If the object is not the first object in a sequence, the object is appended to the end of the current path or sequence being followed by the user and a respective similarity measure is calculated expressing the similarity of the current sequence and each the frequent sequences in the selected multi-user and single user contextual sets of frequent sequences. First, a subsequence length ratio is calculated 218 as follows:

Rᵢ=(length of common subsequence−1)/length of frequent sequence (1)

The length of a common subsequence is determined 218. The length of a common subsequence is the number of elements of the elected sequence that are found in a frequent sequence by deleting elements of the frequent sequence without disturbing the relative positions of the remaining elements. The length of the common subsequence is reduced by one to account for the fact that the first element in the current path and the first element in the contextual frequent sequences are the same. By way of example, if the user follows the election of C with an election of A, the subsequence length ratios for the exemplary frequent sequences and the elected sequence C>A are:

Sequence 1: R₁=2−1/11=1/11

Sequence 2: R₂=1/7

Sequence 3: R₃=0/7

Sequence 4: R₄=1/11

However, the proximity of the common elements in the elected and frequent sequences suggests that as additional elements are added to the current or elected sequence it is more likely that the current sequence will conform to either frequent sequences 2 or 4. To further test the similarity of the elected sequence and the frequent sequences, a weight is applied to the subsequence length ratio recognizing the position of the last common element of the elected and frequent sequence 222. A weight for the position for the position of the last common element can be determined by:

$${W}_{i} = \frac{( length common subsequence - 1 )}{( \begin{matrix}position of last element of common \\ subsequence in frequent sequence , i\end{matrix} )} \qquad ( 2 )$$

The last common element weights for the four exemplary frequent sequences and the current sequence C>A are:

Sequence 1: W₁=2−1/3=1/3

Sequence 2: W₂=1/2

Sequence 3: W₃=0/1

Sequence 4: W₄=1/2

Since prior executions of the sequence by the user currently performing the process are likely to be more predictive of the current sequence than the executions of the sequences by a plurality of other users, a higher weight may be accorded to frequent sequences from the single user set. The multi-user set is particularly useful when little or nothing is known about the current user but the system is expected to anticipate the current user's intent faster from his/her own prior actions than it is from the actions of an unknown group of users. For purposes of the example, the frequent sequences of the single user set are assigned membership weight (Pₛ) of one and frequent sequences of the multi-user set are assigned a membership weight (Pₘ) of ¾ at 224.

For each of the frequent sequences, a weighted common subsequence ratio (Bᵢ); the product of the subsequence ratio (Rᵢ), the position weighting (Wᵢ) and the membership weight (Pᵢ); is computed 226 as follows:

Bᵢ=Wᵢ·Pᵢ·Rᵢ (3)

The weighted common subsequence ratio for the each of the respective exemplary sequences is:

Sequence 1: B₁=1/3·1·1/11=1/33

Sequence 2: B₂=1/2·1·1/7=1/14

Sequence 3: B₃=01·3/4·0/7=0

Sequence 4: B₄=2/3·3/4·2/11=3/88

The objective of the algorithm is to predict that the end of the current sequence intended by the user. To predict the user's intent, the frequent sequences have identical ending sequences are identified 228. One exemplary measure of an identical ending sequence is two or more frequent sequences in which the last two objects in the sequences are identical and in the same order. Of the exemplary frequent sequences, frequent sequences 1 and 4 end in the same sequence of two objects and frequent sequences 2 and 3 end in the same sequence of two objects. The algorithm sums the respective weighted common subsequence ratios (Bᵢ) for the frequent sequences having identical ending sequences to provide a similarity measure expressing a likelihood that the current sequence is a sequence that concludes with the ending of the respective group of frequent sequences 234. The similarity measures (A_{K}), the sums of the weighted common subsequence ratios, for the two sets of exemplary frequent sequences are:

Sequences 1 and 4: A₁₋₄=1/33+3/88=0.064

Sequences 2 and 3: A₂₋₃=1/14+0=0.071

If the similarity measure is greater than a minimum agreement threshold 236 established for the method, A_{K}>minimum agreement, the method concludes that the current sequence is similar to that group of frequent sequences and predicts that the user's intent is to conclude the current sequence with the objects comprising the common ending sequence of that group of frequent sequences 238. Following prediction of the user's intent the method ends 240.

If none of the similarity measures is greater than the minimum agreement threshold, the similarity measure is compared to a minimum probability threshold 242. For example, neither A₁₋₄ or A₂₋₃ is greater than an exemplary minimum agreement threshold of 0.3, and the similarity measures are compared a minimum probability threshold, which for purposes of the example, is set at 0.05.

If none of the similarity measures is greater than the minimum probability threshold, the user may be following a new path in this context but, more likely, thinks that a different context has been selected. If none of the similarity measures is greater than the minimum probability threshold, the algorithm tests the similarity measures against a minimum context threshold 244. If the similarity measures exceed the minimum context threshold, the algorithm awaits the next election. However, if the similarity measures are less than the minimum context threshold, the first object in the sequence is deleted 246. The new sequence typically has a different first object or context and the elections in the new sequence are serially inserted into the method 248. Since the context is new, new sets of frequent sequences are selected from the multi-user and single user sets 214, 216 and the algorithm is repeated for the new set of sequences.

If one or more of the similarity measures is greater than the minimum probability threshold, the algorithm determines whether the number of groups of frequent sequences having similarity measures greater than the minimum probability threshold exceeds a maximum number of options established for the method 250. If the number of frequent sequence groups does not exceed the maximum options threshold, the method retains the frequent sequence groups having similarity measures greater than the minimum probability threshold 252 and awaits the next election. If the number of frequent sequence groups exceeds the maximum options threshold, the method retains the frequent sequence groups having the higher similarity measures 254 and awaits the next election.

For example, neither of the exemplary similarity measures, A₁₋₄ and A₂₋₃, exceed the minimum agreement threshold but both exceed the minimum probability threshold so the method awaits the next election by the user. If, for example, the user elects object D, the object will be appended to the current sequence after the time delay and the current sequence, with appended object (C>A>D), will be compared again to the four exemplary frequent sequences. In this case, A₁₋₄=0.163 and A₂₋₃=0.190. Since both probability measures exceed the minimum probability (0.05) but neither exceeds the minimum agreement threshold (0.3), the algorithm awaits the next election.

If for purposes of the example the next election, is object E, the similarity measures for the current sequence, C>A>D>E, and the groups of frequent sequences are A₁₋₄=0.225 and A₂₋₃=0.321. Since the similarity measure for the group comprising frequent sequences 2 and 3 exceeds the minimum agreement threshold 242, the algorithm returns the prediction 238 that the user intends to elect, sequentially, objects C and I at the end of the current sequence, concluding the method 240. The user intent prediction occurs in real time enabling the system to display information about the expected future elections required of the user or to otherwise assist or automate tasks performed by a sequence of elections.

The detailed description, above, sets forth numerous specific details to provide a thorough understanding of the present invention. However, those skilled in the art will appreciate that the present invention may be practiced without these specific details. In other instances, well known methods, procedures, components, and circuitry have not been described in detail to avoid obscuring the present invention.

All the references cited herein are incorporated by reference.

The terms and expressions that have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims that follow.

I (we) claim:

1. A method for predicting a current intention of an individual, said method comprising the steps of:
(a) determining a frequent sequence of past elections by said individual;
(b) determining a frequent sequence of past elections by a plurality of individuals; and
(c) predicting an intended election by said individual from a sequence of current elections by said individual, said frequent sequence of past elections by said individual and said frequent sequence of past elections by said plurality of individuals.

2. A method for determining an intention of a user making a sequence of elections, said method comprising the steps of:
(a) capturing a plurality of sequences of elections by a plurality of users, said plurality including said user;
(b) identifying a frequent sequence of elections by said user;
(c) identifying a frequent sequence of elections by said plurality of users; and
(d) predicting an intended election by said user from a current election by said user, said frequent sequence of elections by said user and said frequent sequence of elections said plurality of users.

3. The method for determining an intention of a user of claim 2, wherein the step of capturing a plurality of sequences of elections by said plurality of users comprises the steps of:
(a) identifying an individual user;
(b) identifying an object elected by said individual user;
(c) identifying a time of said individual user's election of said object; and
(d) identifying a sequence of elections comprising said election of said object by said individual user.

4. The method for determining an intention of a user of claim 3 further comprising the steps of:
(a) identifying a context of said sequence of elections by said individual user;
(b) identifying said object of said election as not enabled if said object is not enabled in said context; and
(c) identifying said object of said election as not elected in time if said election is not made within a time limit for elections in said context.

5. The method for determining an intention of a user of a device of claim 2 further comprising the step of excluding a temporally earlier election if a succeeding election occurred within a time limit for user interaction.

6. The method for determining an intention of a user of claim 2 wherein the step of identifying a frequent sequence of elections by a plurality of users comprises the steps of:
(a) identifying a context of a sequence included in said plurality of said captured sequences; and
(b) identifying at least one sequence of elections in said context that is frequently selected by said plurality of users.

7. The method for determining an intention of a user of claim 2 wherein the step of identifying a frequent sequence of elections by said user comprises the steps of:
(a) identifying a context of a sequence included in said plurality of said captured sequences;
(b) identifying a sequence of elections by said user included said plurality of captured sequences; and
(c) identifying a sequence of elections by said user that is in said context and frequently selected by said user.

8. The method for determining an intention of a user of a device of claim 6 further comprising the step of identifying a sequence of elections by an environment in which said election was made.

9. The method for determining an intention of a user of claim 2 wherein the step of predicting an intended election by said user from a current election by said user, a frequent sequence of elections by said user and a frequent sequence of elections by said plurality of users comprises the steps of:
(a) detecting election of an object;
(b) appending an identity of said object to a current sequence of elections;
(c) identifying a context of said current sequence;
(d) identifying at least one frequent sequence of elections in said context, said elections of said frequent sequence being made by one of said user and said plurality of users;
(e) determining a measure of similarity of said current sequence and a frequent sequence of elections; and
(f) predicting that said user intends to end said current sequence with an election identical to an ending election of a frequent sequence if a measure of similarity of said current sequence and said frequent sequence exceeds an agreement threshold.

10. The method for determining an intention of a user of claim 8 wherein the step of determining a measure of similarity of said current sequence and a frequent sequence of elections comprises the steps of:
(a) computing a common subsequence ratio relating a number of elections included in said frequent sequence to a number of elections included in a subsequence of said frequent sequence and common to said current sequence;
(b) identifying at least one frequent sequence for said context having a unique ending election; and
(c) summing a respective common subsequence ratio for each frequent sequence having said unique ending election.

11. The method for determining an intention of a user of claim 10 wherein the step of computing a common subsequence ratio relating a number of elections included in said frequent sequence to a number of elections included in a subsequence of said frequent sequence and common to said current sequence comprises the steps of:
(a) determining a number of elections included in a subsequence of said frequent sequence that are common to said elections of said current sequence;
(b) computing a ratio relating said number of elections in said subsequence to a number of elections included in said sequence;
(c) weighting said ratio for a position in said sequence of a last election in said subsequence that is common to said current sequence; and
(d) weighting said ratio for a membership of said frequent sequence in one of a group of frequent sequences comprising elections by said user and a group of frequent sequences comprising elections by said plurality of users.

12. The method for determining an intention of a user of claim 9 further comprising the steps of:
(a) detecting election of an additional object if a measure of similarity of said current sequence and a frequent sequence does not exceed said agreement threshold and if a measure of similarity of said current sequence and a frequent sequence exceeds a minimum probability of agreement threshold;
(b) appending an identity of said additional object to said current sequence of elections; and
(c) predicting that said user intends to end said current sequence with an election identical to an ending election of a frequent sequence if a measure of similarity of said current sequence including said additional object and said frequent sequence exceeds an agreement threshold.

13. The method for determining an intention of a user of claim 12 further comprising the step of limiting a number of measures of similarity of said current sequence and a frequent sequence.

14. The method for determining an intention of a user of claim 9 further comprising the steps of:
(a) amending said current sequence by deleting a first election of said current sequence if a measure of similarity of said current sequence and a frequent sequence does not exceed said agreement threshold and if a measure of similarity of said current sequence and a frequent sequence does not exceed a minimum probability of agreement threshold;
(b) identifying a context of said amended current sequence;
(c) identifying at least one frequent sequence of elections in said context, said elections of said frequent sequence being made by one of said user and said plurality of users;
(d) determining a measure of similarity of said amended current sequence and a frequent sequence of elections; and
(e) predicting that said user intends to end said current sequence with an election identical to an ending election of a frequent sequence if a measure of similarity of said amended current sequence and said frequent sequence exceeds said agreement threshold.

15. A method for determining an intention of a user of a device, said method comprising the steps of:
(a) capturing a current interaction with said device by said user, said interaction comprising selection of a current object;
(b) appending an identity of said current object to a current sequence of objects;
(c) determining a first similarity between said current sequence of objects and a frequent sequence comprising a past selection of an object by at least one of a plurality of users;
(d) determining a second similarity between said current sequence of objects and a frequent sequence comprising past selections of objects by said user;
(e) predicting an object of a future interaction by said user from at least one of said first similarity and said second similarity and a threshold of similarity between said current sequence of objects and a frequent sequence of objects.

16. The method for determining an intention of a user of a device of claim 15 wherein the step of determining a first similarity between a current sequence of objects and a frequent sequence comprising past selection of objects by one of a plurality of users comprises the steps of:
(a) computing a common subsequence ratio relating a number of objects included in said frequent sequence to a number of objects included in a subsequence of said frequent sequence and common with objects included in said current sequence;
(b) identifying at least one frequent sequence for a context of said current sequence having a unique ending object selection; and
(c) summing a respective common subsequence ratio for each frequent sequence having said unique ending object selection.

17. The method for determining an intention of a user of a device of claim 15 wherein the step of determining a second similarity between a current sequence of objects and a frequent sequence comprising past selections of objects by said user comprises the steps of:
(a) computing a common subsequence ratio relating a number of objects included in said frequent sequence to a number of objects included in a subsequence of said frequent sequence and common with objects of said current sequence;
(b) identifying at least one frequent sequence for a context of said current sequence having a unique ending object selection; and
(c) summing a respective common subsequence ratio for each frequent sequence having said unique ending object selection.

18. The method for determining an intention of a user of a device of claim 17 wherein the step of computing a common subsequence ratio relating a number of objects included in said frequent sequence to a number of objects included in a subsequence of said frequent sequence and common with objects of said current sequence comprises the steps of:
(a) determining a number of objects included in a subsequence comprising objects of said frequent sequence that are common to objects of said current sequence;
(b) computing a ratio relating said number of objects in said subsequence to a number of objects included in said sequence;
(c) weighting said ratio for a position in said sequence of a last object in said subsequence; and
(d) weighting said ratio for membership of said frequent sequence in a group of frequent sequences comprising objects selected by said user.

19. The method for determining an intention of a user of claim 15 further comprising the steps of:
(a) detecting election of an additional object if at least one of said first similarity and said second similarity does not exceed said threshold of similarity and if at least one of said first similarity and said second similarity exceeds a minimum probability of agreement threshold;
(b) appending said additional object to said current sequence of objects; and
(c) predicting that said user intends to end said current sequence with an object identical to an ending object of a frequent sequence if a similarity of said current sequence including said additional object and said frequent sequence exceeds said similarity threshold.

20. The method for determining an intention of a user of claim 19 further comprising the steps of:
(a) amending said current sequence by deleting a first object of said current sequence if at least one of said first similarity and said second similarity does not exceed said similarity threshold and if at least one of said first similarity and said second similarity does not exceed a minimum probability of agreement threshold;
(b) identifying a context of said amended current sequence;
(c) identifying at least one frequent sequence of elections in said context, said elections of said frequent sequence being made by one of said user and said plurality of users;
(d) determining a similarity of said amended current sequence and a frequent sequence of objects; and
(e) predicting that said user intends to end said current sequence with an object identical to an ending object of a frequent sequence if said similarity of said amended current sequence and said frequent sequence exceeds said similarity threshold.
